(19) United States
(12) Patent Application Publication
(10) Pub. No.: US 2016/0092876 A1
(43) Pub. Date: Mar. 31, 2016

(54) ON-DEVICE SHARED CARDHOLDER VERIFICATION

(71) Applicant: MasterCard International Incorporated, Purchase, NY (US)

(72) Inventors: Ashfaq Kamal, White Plains, NY (US); Nealle Andrew Page, St Neots (GB)

(21) Appl. No.: 14/811,281

(22) Filed: Jul. 28, 2015

Related U.S. Application Data
(60) Provisional application No. 62/055,826, filed on Sep. 26, 2014.

(51) Int. Cl. G06Q 20/40; G06K 9/00; G06Q 20/32; G06Q 20/36

(52) U.S. Cl. CPC G06Q 20/409; G06Q 20/3674; G06K 9/00597; G06Q 20/40145; G06Q 20/4012; G06Q 20/3227

(57) ABSTRACT

A payment device includes an application storage device for storing a plurality of payment applications and a capture module for capturing user verification information. The payment device also includes a verification module. The verification module is interfaced to the capture module. The verification module is for receiving and verifying the captured user verification information and for outputting a user verification result. The payment device further includes a shared cardholder verification method (CVM) module, which is interfaced to the verification module. The shared CVM module receives the user verification result and also receives a reference to one of the payment applications. The shared CVM module responds to the verification result by outputting an application credential to the payment application to which it was referred.

### CROSS-REFERENCE TO RELATED APPLICATION

This application claims the benefit of U.S. Provisional Patent Application No. 62/055,826 filed on Sep. 26, 2014, the contents of which are hereby incorporated by reference for all purposes.

### BACKGROUND

It has been proposed to implement the functionality of a contactless payment card in mobile devices such as smartphones. According to such proposals, a payment-enabled smartphone may be wirelessly read at a point of sale (POS) terminal, to transfer payment card account information and other relevant information from the payment-enabled smartphone to the POS terminal.

To aid in preventing fraudulent transactions, user verification may be required before the payment-enabled smartphone consummates the exchange of payment information with the POS terminal. For example, the user may be required to enter a secret PIN (personal identification number) into the smartphone to allow the transaction to go forward. According to other proposals, the user verification may be via biometrics. For example, the payment-enabled smartphone may scan and verify the user's fingerprint in order to perform user verification.

According to additional proposals, a number of different payment card accounts may be digitized into a single payment-enabled smartphone, so that the user can choose among the various accounts in deciding which account to use for a particular purchase transaction. Mobile wallet functions have been proposed to run on the payment-enabled smartphone to facilitate the user's choice among payment card accounts and corresponding payment applications hosted on the smartphone.

One difficulty that may be faced in implementation of payment-enabled smartphones with multiple payment card accounts is that each different account/payment application may require a different cardholder verification method (CVM). For example, different PINs may apply to different accounts and/or some accounts/payment apps may require PINs while others require a biometric CVM. The result may be a confusing experience for the user of the payment-enabled smartphone.

### BRIEF DESCRIPTION OF THE DRAWINGS

Features and advantages of some embodiments of the present disclosure, and the manner in which the same are accomplished, will become more readily apparent upon consideration of the following detailed description of the disclosure taken in conjunction with the accompanying drawings, which illustrate preferred and exemplary embodiments and which are not necessarily drawn to scale, wherein:

FIG. 1 is a block diagram representation of a payment system provided in accordance with aspects of the present invention.

FIG. 2 is a block diagram representation of a payment-enabled smartphone provided in accordance with aspects of the present invention.

FIG. 3 is a block diagram that functionally illustrates aspects of the present invention.

FIGS. 4-11 are block diagrams that illustrate various user authentication architectures according to aspects of the present invention.

FIG. 12 is a flow chart that illustrates a process that may be performed in the system of FIG. 1 and payment-enabled smartphone of FIG. 2 in accordance with aspects of the present invention.

### DETAILED DESCRIPTION

In general, and for the purpose of introducing concepts of embodiments of the present invention, a user authentication process result is provided to a shared CVM application in a payment-enabled smartphone. The shared CVM application then provides suitable output to trigger any one of a number of different payment applications that reside on the smartphone. The user authentication process may thus be standardized for all payment transactions undertaken with the payment-enabled smartphone. For example, in some embodiments, the user may submit to a fingerprint scan, which is verified to “unlock” all payment applications on the smartphone. In other embodiments, the user always enters the same PIN as an input to a CVM process, regardless of which payment application the user desires to select for a current purchase transaction.

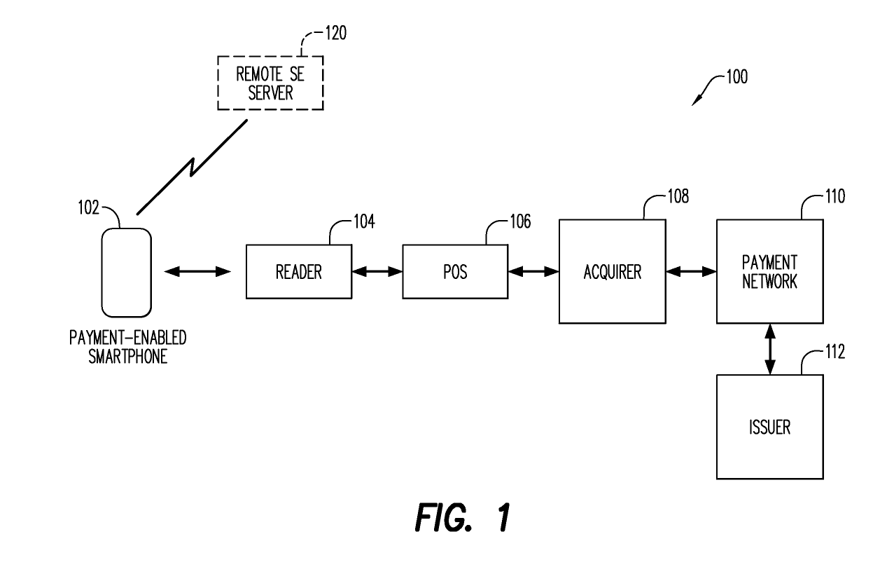

FIG. 1 is a block diagram representation of a payment system 100 provided in accordance with aspects of the present invention.

The system 100 may include a payment-enabled smartphone 102, which may be provided in accordance with aspects of the present invention. Details of various embodiments of the payment-enabled smartphone 102 will be described below.

The system 100 further includes a reader component 104 associated with a POS terminal 106. The reader component 104 is capable of reading a payment card account number or payment token and other information from the payment-enabled smartphone 102. For example, according to known proposals, both the payment-enabled smartphone 102 and the reader component 104 may be equipped with NFC (near field communication) functionality, so that the exchange of data between the payment-enabled smartphone 102 and the reader component 104 may proceed in accordance with the NFC standard.

The reader component 104 and the POS terminal 106 may be located at the premises of a retail store and operated by a sales associate of the retailer for the purpose of processing retail transactions. The payment-enabled smartphone 102 is shown in FIG. 1 to be interacting with the reader component 104 and the POS terminal 106 for the purpose of executing such a transaction.

A computer 108 operated by an acquirer (acquiring financial institution) is also shown as part of the system 100 in FIG. 1. The acquirer computer 108 may operate in a conventional manner to receive an authorization request for the transaction from the POS terminal 106. The acquirer computer 108 may route the authorization request via a payment network 110 to the server computer 112 operated by the issuer of a payment card account that is associated with the payment-enabled smartphone 102. The authorization response may be generated by the payment card issuer server computer 112 and routed back to the POS terminal 106 via the payment network 110 and the acquirer computer 108, in accordance with known practices.

One well known example of a payment network is referred to as the “Banknet” system, and is operated by MasterCard International Incorporated, which is the assignee hereof.

The payment card issuer server computer 112 may be operated by or on behalf of a financial institution (“FI”) that issues payment card accounts to individual users. For example, the payment card issuer server computer 112 may perform such functions as (a) receiving and responding to requests for authorization of payment card account transactions to be charged to payment card accounts issued by the FI; and (b) tracking and storing transactions and maintaining account records.

The components of the system 100 as depicted in FIG. 1 are only those that are needed for processing a single transaction. A typical payment system may process many purchase transactions (including simultaneous transactions) and may include a considerable number of payment card issuers and their computers, a considerable number of acquirers and their computers, and numerous merchants and their POS terminals and associated reader components. The system may also include a very large number of payment card account holders, who carry payment-enabled mobile devices, payment cards or other devices for initiating payment transactions by presenting an associated payment card account number or payment token to the reader component of a POS terminal.

In some embodiments (e.g., when the payment-enabled smartphone 102 does not include a secure element (SE) for hosting payment applications), the payment-enabled smartphone 102 may be in communication (e.g., via a mobile communication network, which is not shown) with a remote SE server 120, which may remotely host and emulate functions of an on-device SE, in accordance with known proposals.

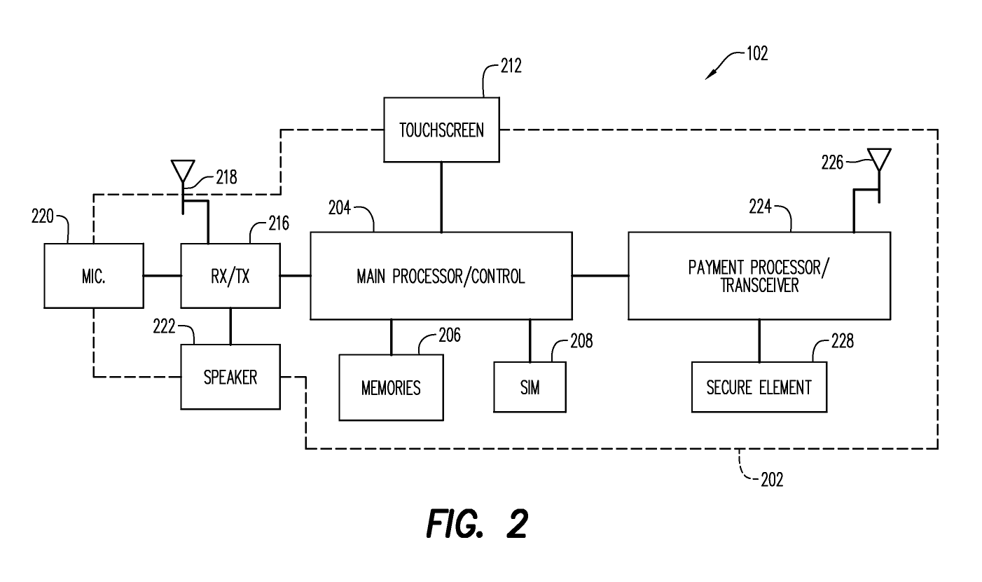

FIG. 2 is a block diagram representation of an embodiment of the payment-enabled smartphone 102 shown in FIG. 1, as provided in accordance with aspects of the present invention.

The payment-enabled smartphone 102 may be conventional in its hardware aspects. For example, the payment-enabled smartphone 102 may resemble, in some or all of its hardware aspects and many of its functions, a conventional “iPhone” marketed by Apple Inc., or one of the numerous smartphone models that run the “Android” operating system.

The payment-enabled smartphone 102 may include a conventional housing (indicated by dashed line 202 in FIG. 2) that contains and/or supports the other components of the payment-enabled smartphone 102. The housing 202 may be shaped and sized to be held in a user's hand, and may for example exhibit the type of form factor that is common with the current generation of smartphones.

The payment-enabled smartphone 102 further includes control circuitry 204, for controlling over-all operation of the payment-enabled smartphone 102. For example, the control circuitry 204 may include a conventional processor of the type designed to be the “brains” of a smartphone.

Other components of the payment-enabled smartphone 102, which are in communication with and/or controlled by the control circuitry 204, include: (a) one or more memory devices 206 (e.g., program and working memory, etc.); (b) a conventional SIM (subscriber identification module) card 208; (c) a conventional touchscreen 212 which serves as the primary input/output device for the payment-enabled smartphone 102, and which thus receives input information from the user and displays output information to the user. As is the case with many models of smartphones, in some embodiments the payment-enabled smartphone 102 may also include a few physically-actuatable switches/controls (not shown), such as an on/off/reset switch, a menu button, a “back” button, a volume control switch, etc. The payment-enabled smartphone 102 may also include a conventional digital camera (as is the case with many smartphones), which is not shown.

The payment-enabled smartphone 102 also includes conventional receive/transmit circuitry 216 that is also in communication with and/or controlled by the control circuitry 204. The receive/transmit circuitry 216 is coupled to an antenna 218 and provides the communication channel(s) by which the payment-enabled smartphone 102 communicates via the mobile telephone communication network (not shown). The receive/transmit circuitry 216 may operate both to receive and transmit voice signals, in addition to performing data communication functions. As is known to those who are skilled in the art, such data communication may be via HTTP (HyperText Transfer Protocol) or other communication protocol suitable for carrying out data communication over the internet.

The payment-enabled smartphone 102 further includes a conventional microphone 220, coupled to the receive/transmit circuitry 216. Of course, the microphone 220 is for receiving voice input from the user. In addition, a loudspeaker 222 is included to provide sound output to the user, and is coupled to the receive/transmit circuitry 216.

The receive/transmit circuitry 216 may operate in a conventional fashion to transmit, via the antenna 218, voice signals generated by the microphone 220, and to reproduce, via the loudspeaker 222, voice signals received via the antenna 218. The receive/transmit circuitry 216 may also handle transmission and reception of text messages and other data communications via the antenna 218.

The payment-enabled smartphone 102 may also include circuitry 224 that is partly or wholly dedicated to implementing NFC communications functionality of the payment-enabled smartphone 102. The payment-enabled smartphone 102 may further include a loop antenna 226, coupled to the NFC circuitry 224. In some embodiments, the NFC circuitry 224 may partially overlap with the control circuitry 204 for the payment-enabled smartphone 102. Moreover, the NFC circuitry 224 is associated with, and may also overlap with, a secure element 228 that may be part of the payment-enabled smartphone 102 and may be contained within the housing 202. The term “secure element” is well known to those who are skilled in the art, and typically refers to a device that may include a small processor and volatile and nonvolatile memory (not separately shown) that are secured from tampering and/or reprogramming by suitable measures. In some embodiments, the secure element 228 may be provided as part of the SIM card 208. In other embodiments, the secure element 228 may be constituted by an integrated circuit card separate from the SIM card 208 but possibly having the same form factor as the SIM card 208. In some embodiments of the payment-enabled smartphone 102, the secure element 228 may be conventional in its hardware aspects but may be programmed in accordance with aspects of the present invention in a manner to be described below. (It should be noted that the term “secure element” is not intended to be limited to devices that are IC-based, but rather may also include any secure execution environment in a mobile device, and may include software based secure execution environments running on the main mobile device processor. In some embodiments, security for payment operations of the payment-enabled smartphone 102 may be achieved without including a physical secure element in the payment-enabled smartphone 102; in such cases, for example, payment card account information and/or payment tokens may be secured in a remote server, as mentioned above in connection with remote SE server 120 of FIG. 1.)

It should also be understood that the payment-enabled smartphone 102 may be operable as a conventional mobile telephone for communication—both voice and data—over a conventional mobile telecommunications network, which is not depicted in the drawing. Thus, the payment-enabled smartphone 102 may be in communication from time to time in a conventional manner with a mobile network operator (“MNO”-also not shown).

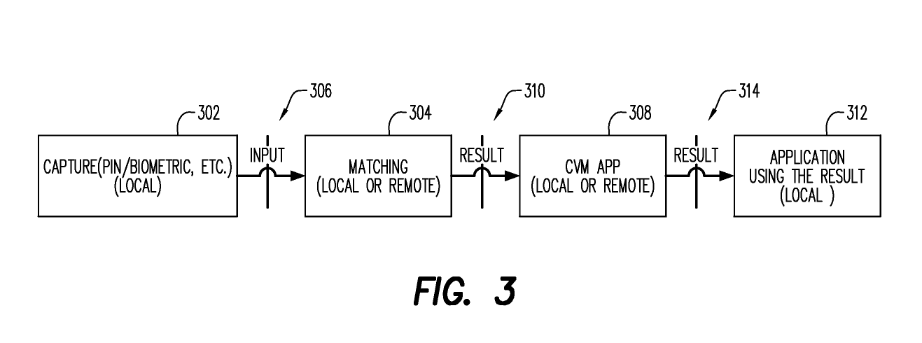

Later sections of this disclosure, including those related to FIGS. 3-12, will describe software and other aspects of the payment-enabled smartphone 102. As is common with smartphones and other computing devices, the processor 204 (and/or the SE 228) may be controlled by program instructions (i.e., software/apps stored in memory devices 206) so as to provide desired functionality. The functionality provided by the processor 204 may be as described herein below.

FIG. 3 is a block diagram that functionally illustrates aspects of the present invention. In general, FIG. 3 illustrates functions related to user verification/authentication which may be performed in the payment-enabled smartphone 102. The user verification functions are illustrated in FIG. 3 at a high level to show a logical framework for more detailed embodiments that are described in connection with subsequent drawings.

Block 302 in FIG. 3 represents capture of user verification information. For example, such capture may include receiving input of a PIN entered by the user (e.g., by user interaction with a virtual keypad displayed on the touchscreen 212 (FIG. 2)). In addition or alternatively, the “capture” represented by block 302 may be with respect to a biometric characteristic of the user. In some embodiments, for example, the payment-enabled smartphone 102 may be configured to scan a fingerprint of the user (e.g., via the touchscreen 212). In another example, the capture may relate to voice recognition (e.g., capturing an utterance spoken by the user into the microphone 220 (FIG. 2)). In still another example, the camera (not shown) of the payment-enabled smartphone 102 may be used to capture an image of the user's face, for purposes of facial recognition analysis. In other embodiments, the smartphone camera may be employed to perform a retinal scan with respect to the user. In some embodiments, other types of biometric features may be used for user verification besides those just listed.

Block 304 in FIG. 3 represents a process of matching the captured user verification information with reference information. Furthermore, an interface 306 between blocks 302 and 304 represents transfer of the user verification input from block 302 to block 304.

Block 308 in FIG. 3 represents an application program (“app”) that receives the result of the user verification made by block 304. The user verification result is communicated from block 304 to block 308 via an interface 310. A function of block 308 is to make the result available to another application. The latter application (represented by block 312) may be, for example, a payment application selected by the user to consummate a current purchase transaction. In other situations, the application 312 may have a function other than payment. The result of the user verification may be made available to application 312 from application 308 via an interface 314. The application 312 may, for example, use the result of the user verification to authorize use of the application 312 for the current transaction. As will be seen, in some embodiments, the payment-enabled smartphone 102 may store a number of different payment applications or other applications to be authorized, case-by-case, via a shared user verification process implemented through blocks 302 and 304. In FIG. 3, block 312 may represent the application selected for use in a particular case (e.g., for a particular transaction). The result provided by the application 308 to the application 312 may enable the latter application to operate; e.g., to engage in a payment transaction requested by the user.

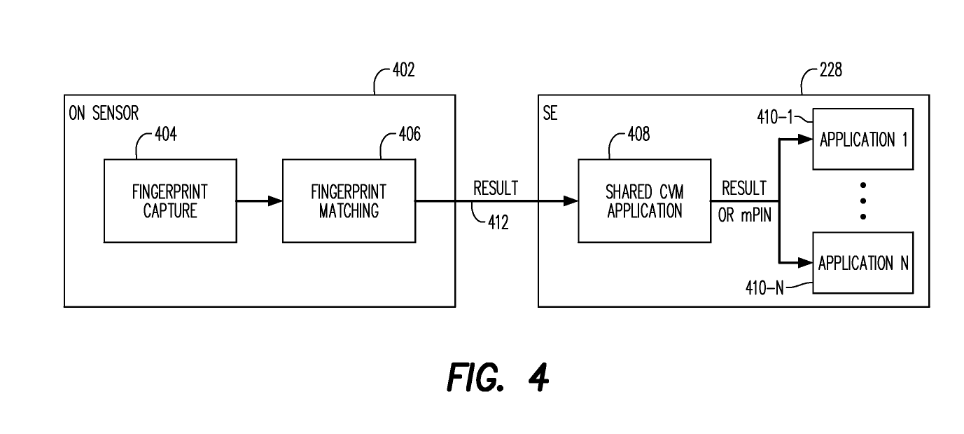

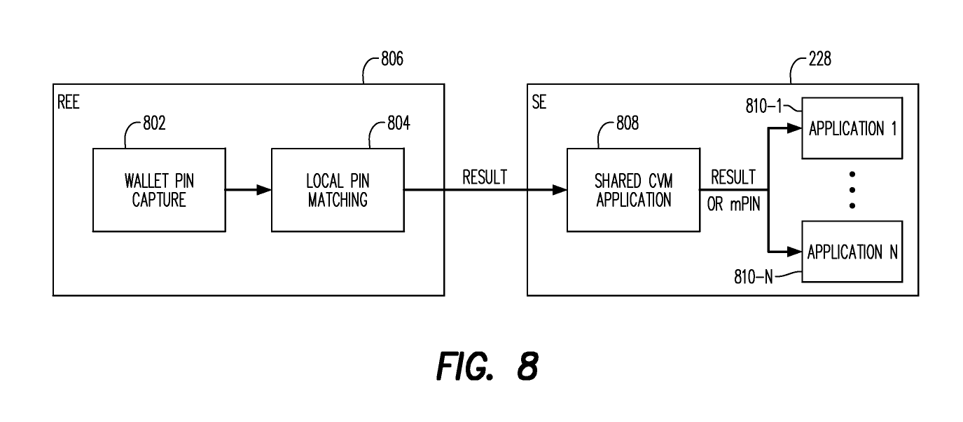

FIGS. 4-11 are block diagrams that illustrate various user authentication architectures according to aspects of the present invention. FIGS. 4-11 may be viewed as illustrating various ways in which the logical pathway of FIG. 3 can be specifically implemented. FIGS. 4-7 all assume that the biometric feature represented by the user's fingerprint is employed for user verification. FIGS. 8-11 all assume that user verification in the payment-enabled smartphone 102 is based on user entry of a predetermined secret PIN. In some embodiments, secret information other than a PIN may be entered into the smartphone by the user for verification by a component/function corresponding to block 304 in FIG. 3. In some embodiments, a biometric interaction other than capturing the user's fingerprint may occur. As used herein and in the appended claims, the term “biometric interaction” refers to any activity by the user and/or the smartphone 102 that results in the smartphone capturing data that represents a physical attribute of the user.

Turning initially to FIG. 4, a fingerprint reading function 402 is incorporated in the payment-enabled smartphone 102. The fingerprint reading function 402 includes both a fingerprint image capture function 404 and a fingerprint matching/verification function 406. In some embodiments, analysis of the captured fingerprint image to generate recognition parameters can take place in block 402 or block 404 or can be divided between those two blocks. In any event, block 404 may implement storage of reference parameters, and matching/comparison of the reference parameters with the recognition parameters generated from the fingerprint image captured by block 404.

Block 402 transmits the result of its verification process to secure element 228 (FIG. 2, assumed to be present in this embodiment). More specifically, the user verification result is provided from block 402 to a shared CVM application 408, which is hosted in the SE 228. The SE 228 also hosts applications 410-l through 410-N. In some embodiments, all of the applications 410 may be payment applications. (Although only two applications 410 are explicitly shown in FIG. 4, it should be understood that the number of such applications may be greater than two.)

The shared CVM application 408 may be operative to transmit the user verification result and/or an mPIN (mobile PIN) to any one or more of the applications 410.

In some embodiments, the applications 408 and 410 may be trusted because they are hosted by SE 228. Moreover, the communication channel 412 from block 406 to the SE 228 may be secure and arranged to resist spoofing of block 402. Consequently, the communication channel 412 can also be trusted, so that the configuration of FIG. 4 tends to prevent wrongdoers from injecting “false positive” user verification results into the SE 228.

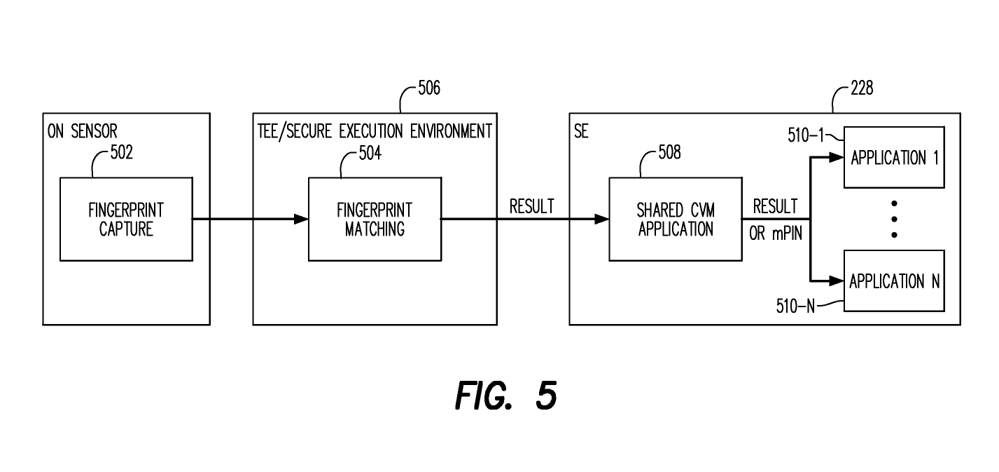

In the embodiment of FIG. 5, the payment-enabled smartphone 102 again includes a fingerprint image capture function (indicated by block 502 in FIG. 5). As before, in some embodiments, the fingerprint image capture function 502 may include some or all of the analysis capability required to produce recognition parameters. In the configuration of FIG. 5, the fingerprint matching/verification function is represented by block 504, and is shown as being separate from the fingerprint image capture function 502 and hosted within a trusted execution environment (TEE)/secure execution environment 506. In FIG. 5, the secure element 228 is depicted as hosting elements (applications), 508 and 510-l through 510-N. The latter elements may correspond respectively to the elements 408 and 410-l through 410-N described above in connection with FIG. 4. Thus, the above description of elements 408 and 410-l through 410-N should be understood also to be applicable to elements 508 and 510-l through 510-N.

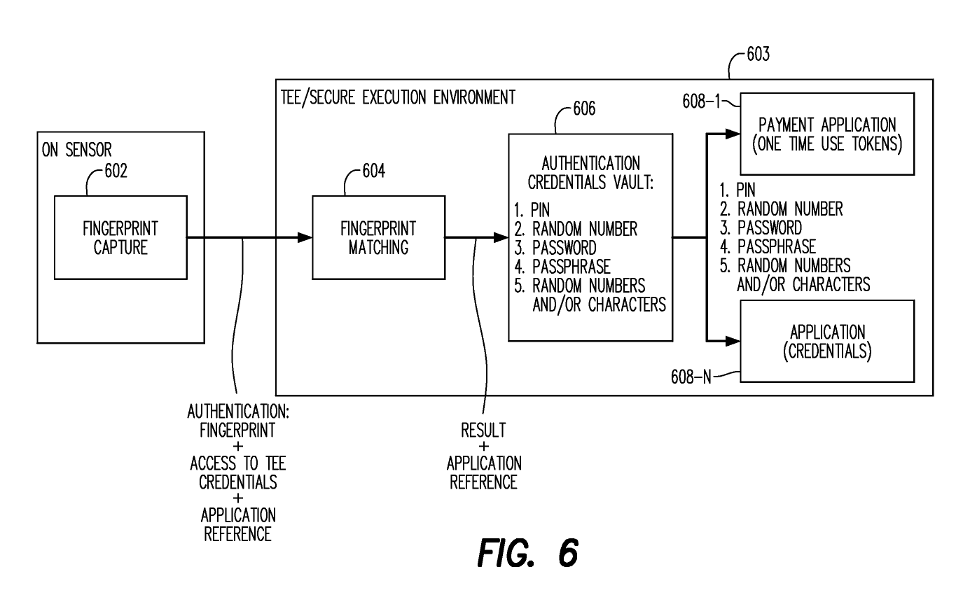

The embodiment of FIG. 6 corresponds to one in which the payment-enabled smartphone 102 may lack a secure element. Rather, security may be provided via a trusted execution environment (TEE)/secure execution environment (reference numeral 603, FIG. 6) that may be established in the main processor 204 (FIG. 2) by suitable software security measures (or that may be established in another manner). The TEE/secure execution environment 603 may, in some embodiments, be established in accordance with conventional principles.

In the embodiment of FIG. 6, the payment-enabled smartphone 102 may include a fingerprint image capture function 602, that is not within the TEE/secure execution environment 603. A fingerprint matching/verification function 604 may be provided within the TEE/secure execution environment 602. The fingerprint matching/verification function 604 may receive, from the fingerprint capture function 602, data generated and/or derived from the capturing of the image of the user's fingerprint by the fingerprint image capture function 602. In addition, the fingerprint matching verification function 604 and/or the TEE/secure execution environment 603 may receive data indicative of credentials to access the TEE/secure execution environment 603, as well as data that include a reference to a payment application that is to be used for a current purchase transaction. The latter data thus may serve as an identification of the payment application to be used.

The fingerprint matching/verification function 604 may match/compare the fingerprint image data received from the fingerprint image capture function 602 to produce a fingerprint verification result. (As part of the match/compare process, the fingerprint matching/verification function 604 may also perform analysis of the fingerprint image data received from the fingerprint image capture function 602.) The fingerprint verification result, as well as the payment application reference data, may be passed to a shared CVM application 606, which is configured to serve as a vault for access credentials for a number of different payment applications 608-l through 608-N. (Although only two payment application blocks are explicitly shown in FIG. 6, the actual number of payment applications present in some embodiments, may be considerably more than two. For example, the shared CVM application 606 is depicted as storing payment application credentials that correspond to at least five different payment applications 608. Thus, in some embodiments, at least five or more different payment applications may be present in the TEE/secure execution environment 603.)

As just noted, the shared CVM application/payment application credential vault 606 may store payment credentials that correspond to a number of different ones of the payment applications 608. For example, the shared CVM application/payment application credential vault 606 may store, and one or more of the payment applications may be configured to be activated by, various types of credentials, including, e.g.: (a) a stored payment application PIN; (b) a random number; (c) a password; (d) a passphrase; (e) a string comprising random numbers and/or characters. In some embodiments, a given payment application 608 may expect to receive two or more of these types of credentials.

If the user verification result received by the shared CVM application/credential vault 606 from the fingerprint matching/verification function 604 indicates verification of the user's fingerprint, then the shared CVM application/credential vault 606 may respond by outputting, to the identified payment application 608, the corresponding credential or credentials for the identified application. Consequently, the identified payment application 608 may be activated and authorized to perform the desired purchase transaction.

Referring to payment application 608-l in FIG. 6, it may be the case that this payment application or another payment application 608 is of a type that communicates a one-time payment token rather than a payment card account number to the POS terminal That is, the payment application 608-l in question may store a number of one-time payment tokens or may receive such tokens on a transaction-by-transaction basis by downloading from a remote SE server 120 (FIG. 1) to the payment application 608-l. The use of one-time payment tokens rather than a payment card account number is a technique that is known to those who are skilled in the art, and may be consistent with a tokenization initiative as described in the “Payment Token Standard” published by MasterCard International Incorporated, Visa and American Express in November, 2013.

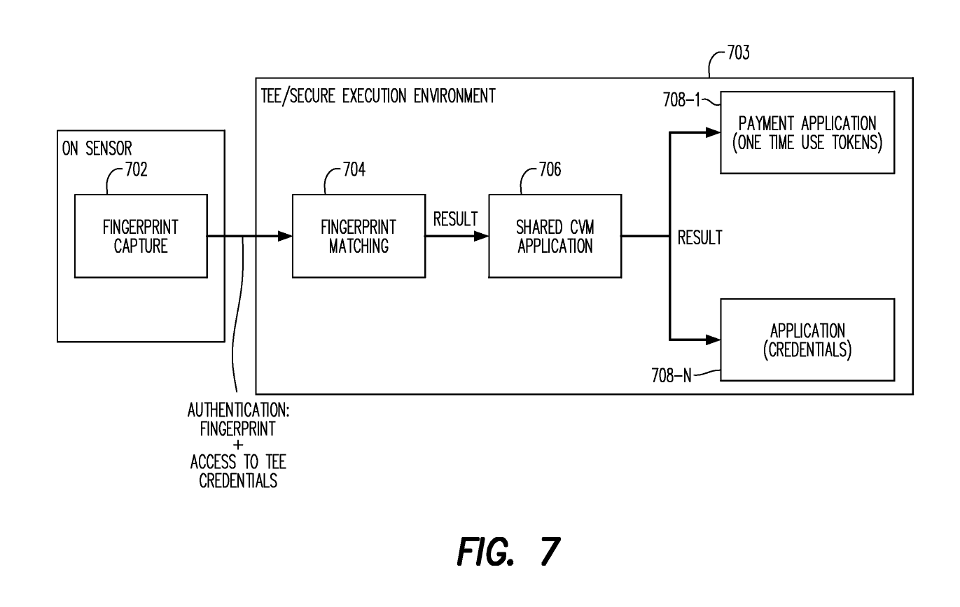

FIG. 7 illustrates another embodiment. In the embodiment of FIG. 7, a fingerprint image capture function 702 may be provided, and may be like the fingerprint image capture function 602 of FIG. 6. In addition, the embodiment of FIG. 7 may include a TEE/secure execution environment 703, which may be like the TEE/secure execution environment 603 of FIG. 6. Moreover, the TEE/secure execution environment 703 of FIG. 7 may host a fingerprint matching/verification function 704, which may resemble the fingerprint matching/verification function 604 of FIG. 6.

In the embodiment of FIG. 7, a shared CVM application 706 is again provided. However, in the embodiment of FIG. 7, the shared CVM application 706 may not serve as a payment application credential vault. For example, the fingerprint matching verification function 704 may receive, from the fingerprint capture function 702, data generated and/or derived from the capturing of the user's fingerprint. In addition, the fingerprint matching verification function 704 and/or the TEE/secure execution environment 703 may receive data indicative of credentials to permit access to the TEE/secure execution environment 703. However, in the embodiment of FIG. 7, the TEE/secure execution environment 703 may not receive (at least at this stage) data that refers to a specific payment application.

As in previous embodiments, the TEE/secure execution environment 703 of FIG. 7 may host a number of payment applications 708-l through 708-N.

The fingerprint matching verification function 704 may match/compare the fingerprint image data received from the fingerprint image capture function 702 to produce a fingerprint verification result. The fingerprint verification result may be passed to the shared CVM application 706. The fingerprint verification result may function as a user verification result.

If the user verification result received by the shared CVM application 706 indicates verification of the user's fingerprint, then the shared CVM application 706 may respond by providing a corresponding result to all (or a selected one of) the payment applications 708. The payment applications 708 may be configured to be activated by the result provided by the shared CVM application 706, and may be configured so as not to require payment-application-specific credentials. The activation of the payment applications 708 may enable them to operate; that is, each of the payment applications may, if selected by the user for the current transaction, be enabled to perform the transaction. The selection of the particular payment application 708 to be used for the current purchase transaction may occur after the transmission of the user verification result from the shared CVM application 706.

Referring now to FIG. 8, in another embodiment the payment-enabled smartphone 102 includes a functional block 802 for capturing a user's input of a PIN (e.g., a mobile wallet PIN) and a functional block 804 for matching/verifying the PIN entry. In the example embodiment illustrated in FIG. 8, blocks 802 and 804 may be hosted in a so-called “rich execution environment” or “REE” (reference numeral 806), which may, e.g., be a conventional mobile OS (operating system) environment. As is quite familiar to those who are skilled in the art, the functional block 804 may involve the user interacting with a virtual keypad (not shown) displayed on the touchscreen 212 (FIG. 2), and suitable capture via a wallet app or the like of the resulting user PIN input.

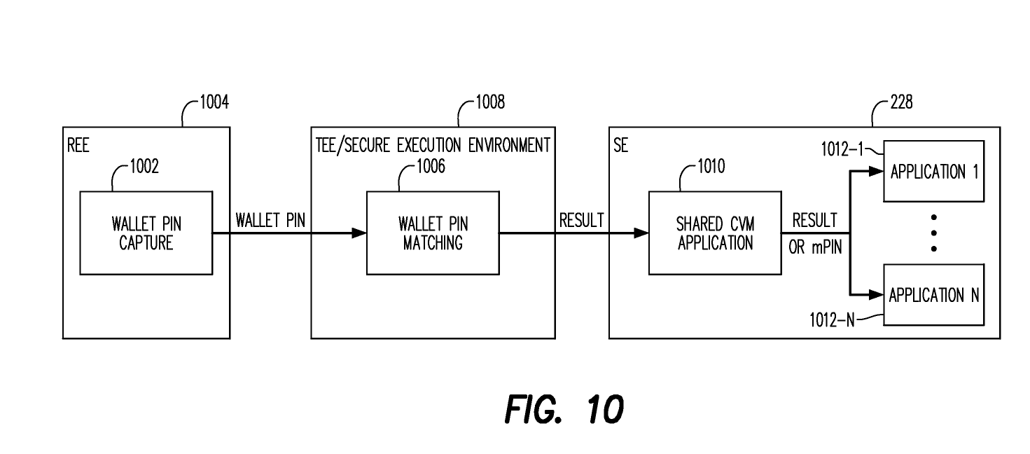

PIN matching/verification block 804 may transmit the result of its verification process to secure element 228 (FIG. 2, assumed to be present in this embodiment). In particular, the user verification result is provided from PIN matching/verification block 804 to a shared CVM application 808, which is hosted in the SE 228. As in the embodiment of FIG. 4, the SE 228 also hosts payment applications, indicated by reference numerals 810-l and 810-N. The above description accompanying FIG. 4 with respect to applications 408 and 408-1 through 408-N is also applicable to the applications 808 and 810-l through 810-N shown in FIG. 10. Accordingly, further description of the embodiment of FIG. 8 is not believed to be needed.

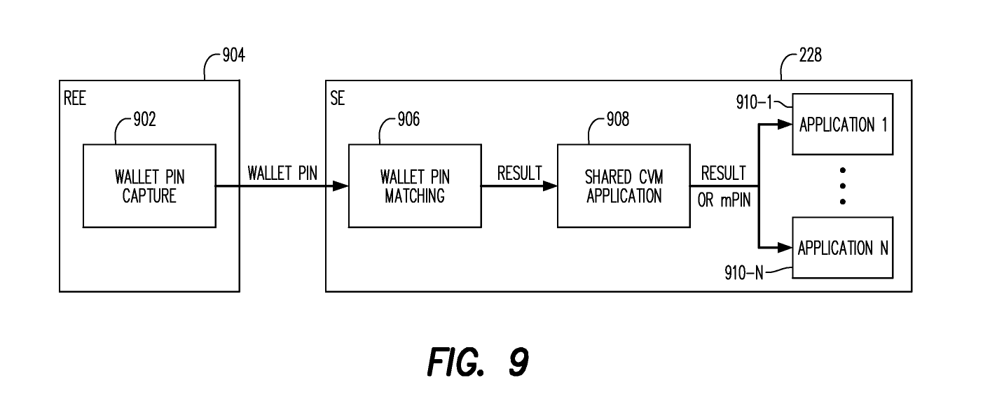

In the embodiment of FIG. 9, the payment-enabled smartphone 102 again includes a PIN capture functional block (reference numeral 902 in FIG. 9), which may again be hosted in an REE (reference numeral 904). In this embodiment, the PIN matching/verification functional block 906 may be hosted on the SE 228. Except for the operating environment in which it is hosted, the functional block 906 of the embodiment of FIG. 9 may resemble the functional block 804 in FIG. 8.

The user verification result provided from the PIN matching/verification functional block 906 may be provided to a shared CVM application 908, which is again hosted in the SE 228. Once more, the SE 228 also hosts payment applications (reference numerals 910-l, 910-N). Moreover, the applications 908 and 910-l through 910-N shown in FIG. 9 may be considered to be described by the above description of applications 408 and 410-l through 410-N in connection with FIG. 4.

Referring now to FIG. 10, once more the payment-enabled smartphone 102 may include a PIN capture functional block (reference numeral 1002), again hosted in an REE (now indicated by reference numeral 1004). In the embodiment of FIG. 10, the PIN matching/verification functional block 1006 may be hosted in a TEE/secure execution environment 1008. As in the embodiments of FIGS. 8 and 9, the SE 228 hosts a shared CVM application (reference numeral 1010) and payment applications 1012-l and 1012-N. The applications 1010 and 1012-l through 1012-N may be the same as like elements described above in connection with FIG. 4. The PIN input may be transmitted from the PIN capture functional block 1002 to the PIN matching/verification functional block 1006 hosted in the TEE/secure execution environment 1008. The user verification result from the PIN matching/verification functional block 1006 may be transmitted to the shared CVM application 1010.

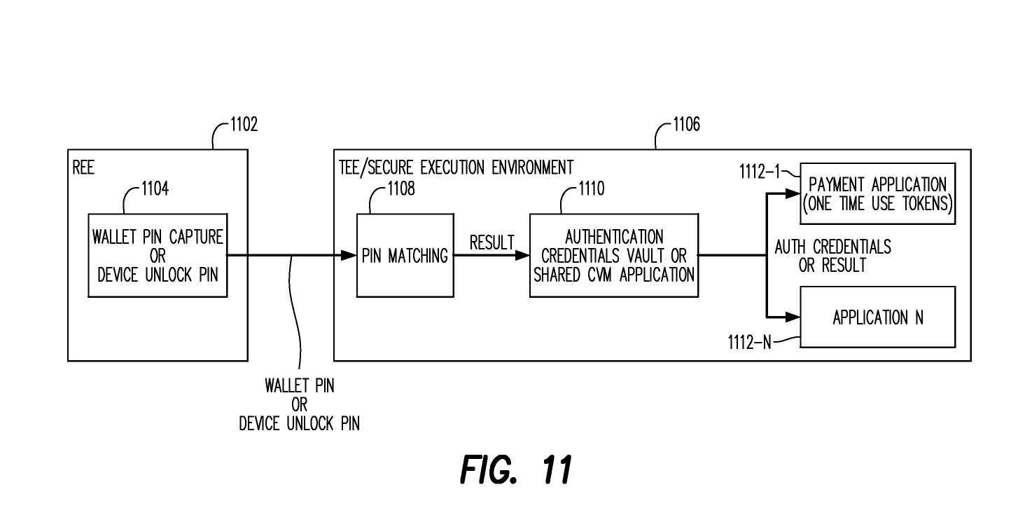

In the embodiment shown in FIG. 11, it is assumed that no secure element is present. Again an REE 1102 may host a PIN capture functional block 1104, which may, for example, operate to receive input of a mobile wallet PIN and/or a device unlock PIN. In the embodiment of FIG. 11, a TEE/secure execution environment 1106 may host all of (a) a PIN matching/verification block 1108; (b) a shared CVM application 1110; and (c) payment applications 1112-l through 1112-N. In some embodiments, the shared CVM application 1110 may additionally or alternatively provide the functionality of an authentication credentials vault for the payment applications 1112, in similar fashion to the element 606 discussed above in connection with FIG. 6. Continuing to refer to FIG. 11, the PIN input (wallet PIN and/or device unlock PIN, as the case may be) may be transmitted from the PIN capture functional block 1104 to the PIN matching/verification functional block 1108 hosted in the TEE/secure execution environment 1106. The user verification result may be transmitted from the PIN matching/verification functional block 1108 to the shared CVM application/credentials vault 1110. In at least some embodiments, the shared CVM application/credentials vault 1110 may provide the corresponding credential to the particular payment application 1112 selected for the current purchase transaction. In other embodiments, the application 1110 may only provide a user authentication result to one or more of the payment applications 1112.

In some examples of the arrangement of FIG. 11, as in other embodiments, one or more of the payment applications 1112 may operate to provide a single use payment token (as discussed above in connection with FIG. 6) instead of providing a payment card account number to the POS terminal.

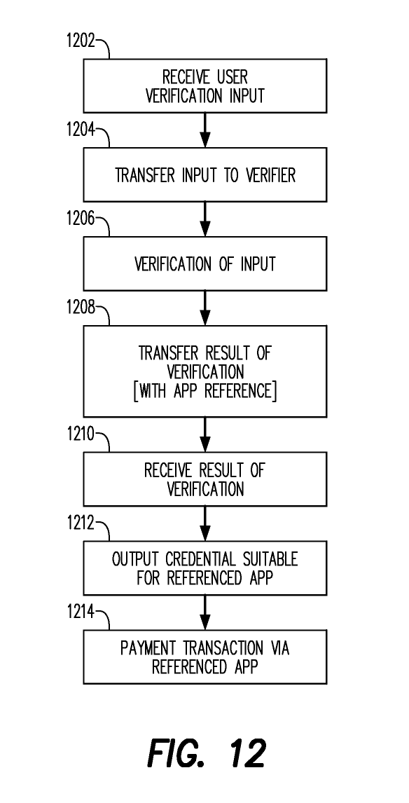

FIG. 12 is a flow chart that illustrates a process that may be performed in the system 100 of FIG. 1 and payment-enabled smartphone 102 of FIG. 2 in accordance with aspects of the present invention.

At block 1202 in FIG. 12, the payment-enabled smartphone 102 may receive user verification input. For example, this may be a biometric input such as a fingerprint scan, or a numeric input (PIN input) via a virtual keypad displayed on the touchscreen 212 (FIG. 2). In some embodiments, for example, the input may be received via a fingerprint capture element/function (e.g., reference numeral 602 in FIG. 6) or via a PIN capture element/function (e.g., reference numeral 1104 in FIG. 11).

At 1204 in FIG. 12, the verification input received/captured at 1202 may be transmitted to a verification element/function, such as the fingerprint matching/verification functional block 604 in FIG. 6 or the PIN matching/verification functional block 1108 in FIG. 11. At 1206 in FIG. 6, the verification element/function performs the required verification process (e.g., as mentioned above, by comparing/matching the verification input with stored reference data, which may be biometric parameters or a previously established PIN value).

At 1208, the verification element/function transmits a verification result to a shared CVM application. As noted above, the shared CVM application may be hosted on a secure element (item 228, FIG. 2), as in the case of the application 508 in FIG. 5 or the application 908 in FIG. 9. In other embodiments, for example, the shared CVM application may be hosted in a TEE, as in the case of applications 606 (FIG. 6) or 1110 (FIG. 10). In some embodiments, the verification result from the verification element function may be transmitted with a reference to a payment application that has been selected for the current purchase transaction (as mentioned above in connection with FIG. 6).

At 1210, the shared CVM application receives the verification result. In response (block 1212), in some embodiments, the shared CVM application may output to a selected payment application an authorization credential that corresponds to (i.e., that is suitable for/expected by) the payment application. Examples of such authorization credentials are provided, for example, in the above discussion of the embodiment of FIG. 6 and especially in connection with element 606 in FIG. 6. The payment applications may be configured such that they are mutually different from each other in terms of the credentials required to authorize the respective payment applications.

At 1214, a transaction is performed by the selected payment application. The transaction may proceed generally as described above in connection with FIG. 1.

With configurations of a payment-enabled smartphone 102 as described above, the user experience may be simplified and streamlined in connection with purchase transactions, and entry of user verification information may be standardized across all payment applications available for use on the payment-enabled smartphone 102. Moreover, the teachings of this disclosure may aid in enhancing security of smartphone-based payment transactions.

In general, the above discussion of the payment-enabled smartphone 102 has been in the context of an in-store transaction in which a payment application on the payment-enabled smartphone 102 has interacted with a POS terminal to effectuate the transaction. Alternatively, however, user verification in the payment-enabled smartphone 102 in accordance with teachings of this disclosure may also be employed in connection with a remote/e-commerce transaction. For example, in some cases, the user may select merchandise on an e-commerce website via the user's PC (personal computer—not shown) or via a mobile browser (not shown) in the payment-enabled smartphone 102, and then during a check-out phase of the transaction, the user may enter into the e-commerce website addressing information for his/her payment-enabled smartphone 102 (or the mobile browser may automatically cause or allow for user authentication to commence). The e-commerce website (i.e., the e-commerce host computer) may then contact the user's payment-enabled smartphone 102 to cause it to perform user verification to help secure the e-commerce transaction from potential fraud.

The above discussion has, in its main examples, referred to user verification via fingerprint scan or PIN entry. However, user verification as referenced herein may take other forms, such as biometric measures of other types, including but not limited to facial recognition and voice recognition. Moreover, as far as entry of secret information is concerned with respect to user verification, such information entry is not limited to PIN entry, but may, for example, alternatively include making a pattern of gestures to be detected via the touchscreen 212 of the payment-enabled smartphone 102 or other entry of patterned information relative to the payment-enabled smartphone 102.

In embodiments where facial recognition is employed for user verification, the payment-enabled smartphone 102 may scan the user's face by capturing an image of the user's face via the smartphone's camera, which is not shown.

In embodiments where voice recognition is employed for user verification, the payment-enabled smartphone 102 may receive a user's spoken utterance (e.g., a predetermined spoken word), via the microphone 220 (FIG. 2).

In embodiments depicted in accompanying drawings in which a secure element is shown, the SE 228 should be understood to be constituted by a physical secure element, rather than a software or other type of arrangement that also may fall within a broad definition of a secure element. Other and/or alternative embodiments may include a “secure element” as more broadly defined instead of a physical secure element.

Furthermore, the above discussion has focused on user verification processes, but the transaction processes described herein may also in some embodiments include device authentication steps, such as when the payment-enabled smartphone 102 and/or payment applications have effectively been preregistered with the payment card account issuer or a transaction services provider and the device and/or the selected payment app is itself subjected to an authentication process.

Still further, the payment-enabled device described herein has been presented as a smartphone. Nevertheless, the teachings of this disclosure are also applicable to providing payment functionality in other types of mobile devices, including tablet computers, and conventional mobile phones that are not smartphones, and also including smartwatches.

In above examples where the shared CVM application has provided a verification result to a payment application, it may additionally be the case that the shared CVM application also indicates to the payment application what manner of user verification took place.

The terms “user verification” and “user authentication” are employed interchangeably in this document.

As used herein and in the appended claims, the term “user authentication component” refers to either or both of a user data capture component such as block 302 in FIG. 3 and a user data matching/verification component such as block 304 in FIG. 3.

As used herein and in the appended claims, the term “computer” should be understood to encompass a single computer or two or more computers in communication with each other.

As used herein and in the appended claims, the term “processor” should be understood to encompass a single processor or two or more processors in communication with each other.

As used herein and in the appended claims, the term “memory” should be understood to encompass a single memory or storage device or two or more memories or storage devices.

As used herein and in the appended claims, a “server” includes a computer device or system that responds to numerous requests for service from other devices.

The flow charts and descriptions thereof herein should not be understood to prescribe a fixed order of performing the method steps described therein. Rather the method steps may be performed in any order that is practicable, including simultaneous performance of at least some of the steps.

As used herein and in the appended claims, the term “payment card system account” includes a credit card account, a deposit account that the account holder may access using a debit card, a prepaid card account, or any other type of account from which payment transactions may be consummated. The terms “payment card system account” and “payment card account” and “payment account” are used interchangeably herein. The term “payment card account number” includes a number that identifies a payment card system account or a number carried by a payment card, or a number that is used to route a transaction in a payment system that handles debit card and/or credit card transactions. The term “payment card” includes a credit card, debit card, prepaid card, or other type of payment instrument, whether an actual physical card or virtual.

As used herein and in the appended claims, the term “payment card system” or “payment system” refers to a system for handling purchase transactions and related transactions. An example of such a system is the one operated by MasterCard International Incorporated, the assignee of the present disclosure. In some embodiments, the term “payment card system” may be limited to systems in which member financial institutions issue payment accounts to individuals, businesses and/or other organizations.

Although the present disclosure has been described in connection with specific exemplary embodiments, it should be understood that various changes, substitutions, and alterations apparent to those skilled in the art can be made to the disclosed embodiments without departing from the spirit and scope of the disclosure as set forth in the appended claims.

What is claimed is:

1. A payment device, comprising:
an application storage device for storing a plurality of payment applications;
a capture module for capturing user verification information;
a verification module, interfaced to the capture module, for receiving and verifying the captured user verification information and for outputting a user verification result; and
a shared cardholder verification method (CVM) module, interfaced to the verification module, for receiving the user verification result, said shared CVM module responding to said result by enabling operation by at least one of said plurality of payment applications.

2. The payment device of claim 1, wherein the shared CVM module stores a plurality of application credentials, each of said stored application credentials corresponding to a respective one of said plurality of payment applications.

3. The payment device of claim 1, wherein the user verification information is biometric data captured by the capture module.

4. The payment device of claim 3, wherein the biometric data is derived from a user's fingerprint, a user's spoken utterance, a scan of a user's face or a scan of a user's retina.

5. The payment device of claim 1, wherein the user verification information is a PIN (personal identification number) entered by a user.

6. The payment device of claim 1, wherein the shared CVM module is at least partially constituted by a secure element (SE) in a smartphone.

7. The payment device of claim 1, wherein the shared CVM module is at least partially hosted in a secure execution environment in a smartphone.

8. A mobile device, comprising:
a processor;
a memory in communication with the processor and storing program instructions, the process operative with the program instructions to:
run a trusted execution environment (TEE);
host a user verification application in the TEE, the user verification application (a) receiving user verification data from outside the TEE, (b) verifying the user verification data by matching with stored user reference data, and (c) providing a user verification result; and
host a shared cardholder verification method (CVM) application in the TEE, the shared CVM application (a) receiving the user verification result from the user verification application, and (b) providing an authorization output to a selected one of a plurality of payment applications hosted in the TEE.

9. The mobile device of claim 8, wherein the mobile device is a smartphone.

10. The mobile device of claim 8, wherein the user verification data is a PIN (personal identification number) that was entered into the mobile device by a user.

11. The mobile device of claim 8, wherein the user verification data is biometric data obtained as a result of a biometric interaction between a user and the mobile device.

12. The mobile device of claim 11, wherein the biometric data was obtained as a result of at least one of: (a) a scan of the user's fingerprint; (b) voice recognition processing with respect to a spoken utterance by the user; (c) a retinal scan with respect to the user; and (d) facial recognition processing with respect to an image of the user's face.

13. The mobile device of claim 8, wherein the authorization output includes at least one of: (i) a stored payment application PIN (personal identification number); (ii) a random number; (iii) a password; (iv) a passphrase; and (v) a string that includes random numbers and/or characters.

14. The mobile device of claim 8, wherein the authorization output includes at least two of: (i) a stored payment application PIN (personal identification number); (ii) a random number; (iii) a password; (iv) a passphrase; and (v) a string that includes random numbers and/or characters.

15. A mobile device, comprising:
a secure element (SE); and
at least one user authentication component in communication with the SE, the at least one authentication component operative to provide to the SE at least one of (a) user verification data, and (b) a result of a user verification process;
the SE operative to host a shared cardholder verification method (CVM) application, the shared CVM application (i) receiving said result or a result based on processing the user verification data; and (ii) providing an authorization output to a selected one of a plurality of payment applications hosted in the SE.

16. The mobile device of claim 15, wherein the at least one user authentication component receives input of a PIN (personal identification number) from a user of the mobile device, said PIN being either said user verification data or an input to said user verification process.

17. The mobile device of claim 15, wherein the at least one user authentication component generates biometric data based on a biometric interaction between the mobile device and a user.

18. The mobile device of claim 17, wherein the biometric data was obtained as a result of at least one of: (a) a scan of the user's fingerprint; (b) voice recognition processing with respect to a spoken utterance by the user; (c) a retinal scan with respect to the user; and (d) facial recognition processing with respect to an image of the user's face.

19. The mobile device of claim 15, wherein the mobile device is a smartphone.

20. The mobile device of claim 15, wherein the SE is a physical SE.
